(19) United States
(12) Patent Application Publication
(10) Pub. No.: US 2021/0103900 A1
(43) Pub. Date: Apr. 8, 2021

(54) BID-BASED SELECTION OF ACQUIRING BANKS FOR TRANSACTION PROCESSING

(71) Applicant: Square, Inc., San Francisco, CA (US)

(72) Inventors: Kalyani Iyer, San Francisco, CA (US); Jason Rosenberg, Athens, GA (US)

(73) Assignee: Square, Inc.

(21) Appl. No.: 15/458,802

(22) Filed: Mar. 14, 2017

(51) Int. Cl. G06Q 20/02; G06Q 20/20; G06Q 20/24; G06Q 20/34

(52) U.S. Cl. CPC G06Q 20/027; G06Q 20/34; G06Q 20/24; G06Q 20/202

(57) ABSTRACT

A merchant services provider may implement a payment processing system for processing card-based transactions on behalf of merchants. The merchant services provider may have relationships with multiple acquiring banks, and may use different acquiring banks for different transactions. The payment processing system electronically solicits bids from the multiple acquiring banks for processing a group of future purchase transactions, wherein the group is specified as a quantity of transactions having certain attributes. The acquiring banks provide respective bids that specify fee amounts for processing the group of transactions. The payment processing system selects a winning acquirer, and subsequently uses the winning acquirer for processing transactions having the specified attributes.

### BACKGROUND

Point-of-sale (POS) devices are used by merchants to perform transactions using customers' credit cards and other payment instruments. At or after the time of a purchase, a purchase transaction is implemented in a process that involves authorization, capture, and settlement of a transaction amount.

For payment instruments such as credit cards and debit cards, the transaction process involves several entities, including an issuing bank, an acquiring bank, and a card payment network. The issuing bank is the bank that issues the payment instrument. The acquiring bank is the bank that accrues funds on behalf of the merchant The card payment network coordinates transactions and settlements between the various entities. Visa®, MasterCard®, American Express®, and Discover® are examples of well-known card payment networks.

Each of the entities mentioned above receives a fee for each transaction, and the various fees are passed to the merchant For example, the payment network may charge a fixed fee for every transaction. In addition, both the acquiring bank and the issuing bank typically receive a fee for each transaction.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram illustrating an example system for conducting transactions using acquiring banks that have won auctions for processing the transactions.

FIG. 2 is a flow diagram illustrating an example method of soliciting and obtaining acquirer bids for processing a group of future transactions.

FIG. 3 is a flow diagram illustrating an example method of conducting transactions in accordance with previously accepted acquirer bids.

FIG. 4 is a flow diagram illustrating an example method performed by an acquirer to process a purchase transaction in accordance with a previously accepted bid.

FIG. 5 is a block diagram of an example server that may be used by a payment processing system or by an acquiring bank to implement the techniques described herein.

### DETAILED DESCRIPTION

Introduced here is a technique that enables more efficient processing of card-based and similar types of purchase transactions by using an auction mechanism. In particular, the technique allows acquiring banks to offer competing bids for processing purchase transactions. When implemented by a merchant services provider, the technique can result in reduced transaction processing fees. Savings can benefit the merchant services provider and/or the supported merchants In addition, higher costs for risker transactions can be passed through to the merchants responsible for those transactions, while merchants conducting lower-risk transactions can benefit from the reduced acquirer fees obtained through the auction mechanism.

In a described embodiment, a merchant services provider implements a payment processing system as a network-based service. The payment processing system acts on behalf of merchants to conduct financial transactions, also referred to herein as payment exchanges, that involve electronic payments based on customer-provided payment instruments. Payment instruments may comprise credit cards, debit cards, gift cards, electronic tokens, stored value cards, and so forth.

A merchant uses a point-of-sale (POS) device to enter purchase information and to accept payment instruments. For each transaction, the POS device sends transaction information to the payment processing system. Among other things, the transaction information includes the transaction amount, also referred to herein as an exchange amount, and an identifier of the payment instrument (such as a credit card number).

Upon receiving a transaction request and accompanying transaction information, the payment processing system communicates with an acquiring bank to initiate a process of transferring funds from the issuing bank of the payment instrument to a bank account associated with the merchant services provider. The acquirer then communicates with a payment processing system payment network, such as one of the Visa® or MasterCard® card networks, to complete the transaction.

This process incurs several fees. For example, the acquiring bank typically charges a fee that has been negotiated with the merchant services provider. In addition, the card payment network, the issuing bank, and the merchant services provider receive fees. Some or all of these fees may be passed on to the merchant by deducting the fees from the transaction amount before crediting the merchant

In some cases, the merchant services provider may have relationships with one or more acquiring banks, and may select any one of those banks to act as the acquirer for any given transaction.

In certain implementations described herein, the payment processing system implements an electronic bidding system so that multiple acquirers can submit bids for processing a specified category of transactions, where the bids specify the acquirer fee amounts that will charged by the banks for processing the transactions. The payment processing system may accept one of the bids, and in the future may use the bank that submitted the accepted bid for processing transactions of the specified category.

More specifically, the payment processing system may electronically provide a request for bids to multiple acquiring banks. The request identifies a transaction category, and in some cases may specify a number of transactions that are to be processed by an acquiring bank. Any or all of the banks may provide a bid in response to the request, where each bid indicates a price at which the transactions of the identified category will be processed. When a bid of a particular bank is accepted by the payment processing system, that bank will be expected to process transactions that are within the identified transaction category, at the bid price.

In certain embodiments, the transaction category may be defined in terms of transaction attributes. Transaction attributes for a given transaction may include, for example, the transaction amount, the merchant category code (MCC) of the merchant conducting the transaction, the credit rating of the merchant, whether the transaction is a card-present transaction, the location where the transaction was conducted, the time when the transaction was conducted, the historical chargeback rate of the merchant, etc.

In some embodiments, the transaction category may include a risk category, and may be defined by one or more risk-related attributes and corresponding allowed attribute values. For example, a particular transaction category may be defined to include transactions that (a) are card-present transactions; (b) have transaction amounts within a specified range; and (c) are conducted by a merchant having a least a threshold credit rating. For purposes of defining a transaction category, the allowed value or values for any particular attribute may be specified as a single value, multiple values, or one or more ranges of values.

In some embodiments, a bid request may be for a tranche of transactions that is defined by time and by one or more other parameters such as risk, transaction amount, merchant category code (MCC), etc. As one example, example, a tranche may be defined as those transactions that occur over a specified time period and that have certain risk characteristics. As another example, another tranche may be defined as transactions for amounts under $100 that occur during a specified time period.

The actual number of transactions within a tranche may depend on the length of the specified time period, and may also depend on the one or more other parameters. For example, a particular tranche might include relatively low risk transactions occurring over a very short time period, while another tranche might include less frequently occurring high risk transactions that occur over a longer time period.

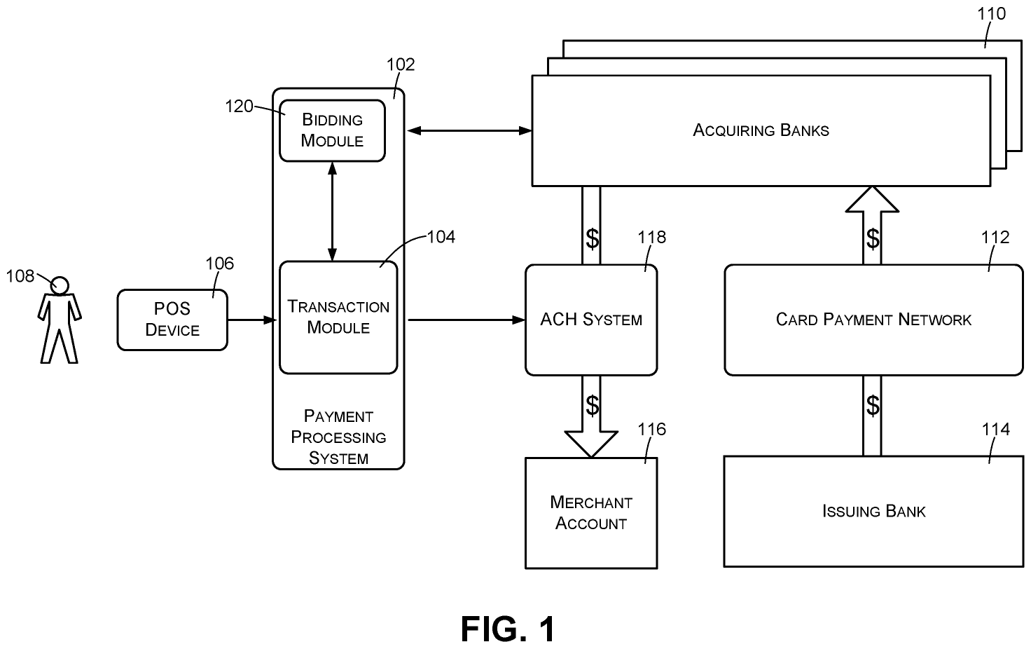

FIG. 1 shows components and entities that may be involved in processing certain types of transactions that are based on payment instruments. The system 100 includes a payment processing system 102, also referred to herein as a payment support system or a support system, that provides purchase transaction support to businesses. The payment processing system 102 provides what are sometimes referred to as merchant services, and may be implemented by a merchant services provider. Generally, actions attributed herein to the payment processing system 102 or to the merchant services provider are performed by one or more server computers (not shown) on behalf of the merchant services provider.

The payment processing system 102 enables and facilitates payment processing for point-of-sale (POS) transactions between merchants and customers. More specifically, the payment processing system 102 includes payment processing software, hardware, and/or services that enable a merchant to receive payments from customers when conducting purchase transactions with the customers. For example, in the embodiment of FIG. 1 the payment processing system 102 has an executable transaction module 104 that enables a merchant to conduct purchase transactions, also referred to herein as payment exchanges, using credit card payments, debit card payments, mobile payments, and/or different types of electronic payments from customers. The transaction module 104 may also be used by online merchants to conduct transactions for which customers are not physically present.

The payment processing system 102 interacts with multiple POS computing devices 106, also referred to herein as POS devices 106, which are associated respectively with different merchants 108. The POS devices 106 are used by the merchants 108 and by the payment processing system 102 to process payments for purchase transactions from customers.

Generally, the POS devices 106 may comprise any of various types of devices, such as terminals, computers, registers, portable devices (tablet computers, smartphones, etc.) and so forth. In some cases, the POS devices 106 may incorporate or work in conjunction with card readers for reading credit cards and/or other payment instruments. In some cases, the POS devices 106 may enable mobile payments, such by allowing a customer to use a smartphone or other mobile device to pay for a purchase transaction. More generally, a POS device is configured to receive information from a payment instrument, which may comprise a physical card or an electronic token or data object, and to interact with the payment processing system 102 to facilitate the transfer of funds from the customer to the merchant based on the information from the payment instrument.

The payment processing system 102 may comprise a large-scale service that supports many merchants, who may be distributed across large geographic areas. In some cases, the payment processing system 102 may implement POS services and other merchant services through pages of a website that are accessed by the POS device 106 of the merchant 108. In these cases, the POS device 106 may comprise a device such a tablet computer or other portable device that accesses the pages of the web site using an Internet browser. In other cases, tablet computers or other devices may run special-purpose applications that are specifically configured to implement POS services in conjunction with the payment processing system 102, using network APIs (application program interfaces) that are made available by the payment processing system 102.

A customer pays for a purchase transaction by providing a payment instrument such as a debit card, a credit card, a stored-value card, a gift card, a check, an electronic token provided by a device carried by the customer, etc. The merchant 108 can interact with the POS device 106 to process the transaction, such as by inputting (e.g., manually, via a magnetic card reader, NFC (near-field communications sensor), RFID (radio frequency identifier) reader, etc.) an identifier associated with the payment instrument. For example, a payment instrument of one of the customers may include one or more magnetic strips for providing card and customer information when swiped in a card reader. In other examples, other types of payment cards may be used, such as smart cards having built-in memory chips, RFID tags, NFC chips, etc. that are read by the POS device 106 when the cards are “dipped” into the reader. The merchant and/or the POS device 106 may also provide other transaction information describing the transaction, such as a transaction amount, the item(s) being purchased, a time, place and date of the transaction, a card payment network associated with the payment instrument, an issuing bank of the payment instrument, and so forth.

The POS device 106 sends the transaction information to the payment processing system 102 over a data communications network (not shown) with instructions to obtain payment of the specified transaction amount. The payment processing system 102 communicates with a selected one of multiple acquiring banks 110, requesting the selected acquiring bank 110 to complete the transaction using a payment network 112. The payment network 112 may comprise any one of several available card payment networks, such as MasterCard®, VISA®, Discover®, American Express®, Star®, etc.

In practice, processing a transaction involves multiple phases, known as “authorization,” “capture,” and “settlement.” Initially, the payment processing system 102 obtains authorization to charge a given amount to the account associated with a payment instrument. In some cases, the authorization may be for an amount that is larger than the pending transaction, particularly in situations in which the final purchase amount is unknown. As an example, an authorization may be for an amount that accounts for an anticipated tip, in addition to the price of the goods or services that are being purchased.

When a transaction has been authorized and is ready for completion, the payment processing system 102 initiates “capture” of the settlement for an amount that is equal to or less that the amount of the previously obtained authorization. Capture initiates the transfer of funds from an issuing bank 114, which is linked to or associated with the payment instrument of the customer, to the selected one of the acquiring banks 110. Actual funds transfer takes place during “settlement,” which may happen over some period of time following capture.

This process may be repeated for different merchants, customers, types of payment instruments, payment networks, and banks.

Note that the issuing bank 114 may be referred to more generally as an issuer 114, and the acquiring banks 110 may be referred to more generally as acquirers 110. Actions attributed herein to an issuer 114 are performed by one or more computer devices or servers on behalf of the issuer 114. Actions attributed herein to an acquirer 110 are performed by one or more computer devices or servers on behalf of the acquirer 110.

The acquiring banks 110 may have relationships with the provider of the payment processing system 102 in order to receive funds on behalf of the merchant services provider. Specifically, a merchant services provider might have bank accounts with the acquiring banks 110, into which received funds are deposited by transfer from the issuing bank 114.

Although only a single issuing bank 114 is shown in FIG. 1, the card payment network 112 may process numerous transactions using payment instruments associated with many different issuing banks. Furthermore, different transactions may be conducted using different card payment networks 112. Generally, various transactions may be conducted using various combinations of acquirers, issuers, and payment networks. When a transaction is processed by a particular combination of acquirer, issuer, and payment network, the transaction is said to have been routed to those entities. For example, routing a transaction to an acquirer means that that acquirer has been designated to process that transaction.

After one or more transactions are conducted by the merchant 108, the payment processing system 102 transfers funds corresponding to the transactions to a merchant bank account 116 that is associated with the merchant 108. Funds transfers from the acquiring bank 110 to the merchant bank account 116 may be performed using an ACH (Automated Clearing House) batch transfer system 118, as an example. ACH is an electronic financial network that processes large volumes of electronic funds transfers in batches, typically overnight. Debit card transfers may also be used for faster disbursements to merchants

The payment processing system 102 may have an executable bidding module 120 that electronically solicits bids or other responses from the acquiring banks 110 prior to routing transactions to those acquiring banks 110. In some cases, the bidding module 120 may expose network interfaces that are accessible by the acquiring banks 110 for communications regarding transaction bids.

To initiate a bidding process, the payment processing system 102 issues a bid request, which is communicated to the acquiring banks electronically using one or more wide-area communication networks such as the Internet. In some embodiments, the acquiring banks 110 may periodically poll the bidding module 120 to discover bid requests. In other embodiments, the bidding module 120 may proactively communicate with the acquiring banks 110 to notify the acquiring banks 110 of bid requests.

A bid request specifies a group of future transactions that are to be processed by a selected acquirer 110. As used herein, the term “future” indicates transactions for which authorization and/or capture occur in time after acceptance of a bid that has been provided in response to the bid request. In some cases, the group of transactions may comprise transactions that are initiated by one or more merchants subsequent to issuing the bid request and/or selecting a winning bid corresponding to the bid request. In other cases, the group of transactions may comprise transactions that have already been initiated by one or more merchants, but for which authorization has not yet been initiated.

In some cases, the group of transactions may be specified by a transaction category and a quantity of transactions that are to be processed in accordance with the bid request. In other cases, the group of transactions may be specified by a transaction category, which may in turn specify a specified time period during which the transactions of the group will occur. In some cases, the bid request may specify a time limit during which the terms of any accepted bid will be valid. The bid request may also specify a time period during which bids will be received.

In response to a bid request, each acquiring bank 110 may submit a bid corresponding to the request. The bid of a particular acquiring bank 110 indicates the price that the acquiring bank 110 will charge for processing transactions specified by the bid request. In some embodiments, the bid may also indicate other terms under which the acquiring bank will process the specified transactions.

Upon receiving bids from multiple acquiring banks 110, the bidding module 120 selects the acquiring bank 110 that submitted the lowest-cost bid, and notifies the selected bank 110 that its bid has been accepted. The selected acquiring bank will be referred to herein as the winning acquiring bank or as the winning acquirer. A bid identifier may also be exchanged so that the bid and its terms can be referred to at a later time.

Subsequently, at a time after accepting the bid, the payment processing system 102 conducts various purchase transactions, some of which fall within the transaction category that was specified in the bid request. Transactions that fall within the specified transaction category will be referred to as qualifying transactions.

Over time, some or all of the qualifying transactions are routed by the payment processing system 102 to the winning acquirer 110. In some embodiments, the bid identifier may be provided to the winning acquirer along with each transaction request so that the winning acquirer knows to process the transaction according to the terms of the bid. The payment processing system 102 continues to process qualifying transactions in this manner, using the winning bank as acquirer, until the winning acquirer has processed all of the transactions of the specified transaction category or until the winning acquirer has processed the quantity of transactions specified by the bid request.

In practice, the payment processing system 102 may issue multiple bid requests, and may separately determine a winning acquirer for each of the requests. In some cases, for example, the payment processing system 102 may issue multiple bid requests, either concurrently or over time, for transactions of a single category. The payment processing system 102 may also issue multiple requests that specify respectively different transaction categories, which might be exclusive or partially overlapping. When subsequently conducting transactions, the payment processing system 102 routes the transactions to different winning acquirers, depending on the categories for which the transactions qualify and the categories for which each winning acquirer has submitted a winning bid.

The quantity of transactions covered by a single request and corresponding bid may vary depending on priorities and practices implemented by the payment processing system 102. For example, a bid request might specify a number that is approximately the number of qualifying transactions that occur during a single 24-hour period. As another example, a bid request might specify a number of transactions that is approximately equal to the number of qualifying transactions that occur during a smaller time period such as 1 second. Thus, the rate at which bid requests are issued may also vary. In some cases, the payment processing system 102 may issue a first bid request and accept a corresponding bid, and then issue a similar second bid request sometime before the number of transactions specified by the first bid have been processed. In some cases, bid requests for a single category may be issued numerous times throughout a day.

In some situations, rather than explicitly specifying a particular number of transactions, a request may specify that responsive bids are for transactions occurring within a certain time period. The time period may be defined by a starting time and an end time, which might encompass any length of time such as a second, an hour, or a day. In certain embodiments, such a time period may be indicated as part of a category criterion as described below.

In situations where an explicit number of transactions is not specified, the actual number of transactions encompassed by the request may be determined indirectly by attributes relating to time and one or more other factors such as risk, transaction amount, etc. For example, a category may be defined to include transactions having a relatively frequently occurring risk characteristic that occur within a very short time period. Conversely, a category may be defined to include transactions having a relatively infrequently occurring risk characteristic during a relatively longer time period.

In some cases, the request might specify a time limit, before which a specified number of transactions will be routed to the winning acquirer.

Communications between the various components of FIG. 1, such as the POS device 106, the payment processing system 102, the card payment network 112, the issuers 114, the acquirer 110, the ACH batch transfer system 118, and various other entities that may be associated, for example, with the issuing bank 114, the acquiring bank 110, and the merchant bank account 116, may be implemented through a network infrastructure such as the Internet. More generally, communications may utilize local area networks, wide area networks, wired networks, Wi-Fi and other wireless networks, cellular data networks, close-range wireless communications such as Bluetooth®, near field communications (NFC), etc. Protocols for communicating over such networks are well known and will not be discussed herein in detail. Various types of encryption and security techniques may be employed to protect communications from eavesdroppers.

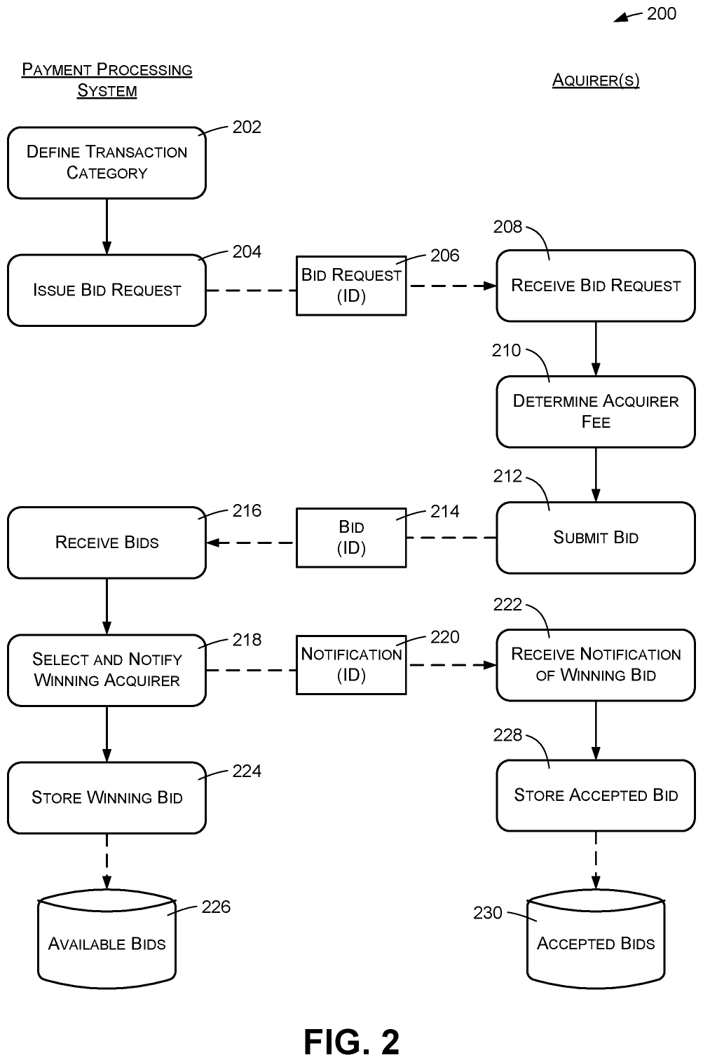

FIG. 2 illustrates an example method 200 of obtaining bids for processing a group of future purchase transactions. The method 200 may be performed in the environment of FIG. 1 or in other environments. The actions illustrated along the left side of FIG. 2 are performed by computing devices of the payment processing system 102, such as by the bidding module 120 of the payment processing system 102. The actions illustrated along the right side of FIG. 2 are performed by computing devices of one or more acquiring banks 110.

An action 202 comprises defining a transaction category. In the embodiments described herein, the transaction category may correspond at least in part to a risk category. Transactions of different categories might present different risks to the acquirers of the transactions, with transactions of some categories presenting more risk than others. Multiple categories may be defined for transactions having different risk levels.

A transaction category may in some cases also correspond to a time period during which qualifying transactions will occur.

In certain embodiments, a category may be defined by a category criterion, and the action 202 may comprise identifying or defining such a category criterion. In certain embodiments, a category criterion may be based at least in part on multiple transaction attributes, some of which may relate to acquirer risk, such as chargeback risk, for processing a given transaction. In various embodiments, transaction attributes of a particular payment exchange may indicate or correspond to any one or more of the following:

an amount of the particular payment exchange;

a time-of-day of the particular payment exchange;

a time of the particular payment exchange;

a length of time in the past of the particular payment exchange;

a length of time in the future of the particular payment exchange;

an identity of a merchant or other entity conducting the particular payment exchange;

a category code, such as a merchant category code (MCC) corresponding to the merchant or other entity conducting the particular payment exchange;

a measure of chargebacks for past purchase transactions conducted by the merchant or other entity conducting the particular payment exchange;

a measure of chargebacks for past purchase transactions conducted with an issuer of the payment instrument being used for the particular payment exchange;

a credit rating of the merchant or other entity conducting the particular payment exchange;

whether the particular payment exchange was a card-present exchange;

whether the particular payment exchange was a telephone-based exchange;

whether the particular payment exchange was an online exchange; an issue date of the payment instrument used for the particular payment exchange;

an expiration date of the payment instrument used for the particular payment exchange;

a county of the issuing bank associated with the payment instrument used for the particular payment exchange;

a bank identification number (BIN) associated with the payment instrument used for the particular payment exchange;

a product type of one or more products being purchased as part of the particular payment exchange;

an identity of an issuer of the payment instrument used for the particular payment exchange;

a billing method associated with the particular payment exchange, such as whether the payment exchange is for an advance payment, a subscription, a retainer, etc.; or

a geographic location where the particular payment exchange was conducted.

A category criterion may be defined by specifying one or more allowed values or constraints for each of one or multiple transaction attributes. In certain embodiments, a set of allowed values, referred to herein as a value set, may be specified for each of the one or more transaction attributes. Each value set may comprise a value, multiple values, a range of values, and/or multiple ranges of values. As an example, the attribute “location” may have an allowed value of “Oregon”. As another example, the attribute “transaction type” may have allowed values of “online” and “telephone”. As yet another example, allowed values of the attribute “transaction amount” may comprise any of the values in the range of $1000 to $2000.

A category criterion can be expressed or specified as a list of attribute names and respectively corresponding value sets. The following is an example of a criterion specification, specifying a value set for each of the attributes “location”, “transaction type”, and “transaction amount”:

“location”={“Oregon”}

“transaction type”={“online”, “telephone”}

“transaction amount”={1000-2000}

Assuming that a category criterion has been defined, the bidding module 120 communicates over a data communications network with the multiple acquirers 110 to solicit and obtain respective bids or other responses for processing a group of future purchase transactions whose attribute values satisfy the category criterion. Specifically, an action 204 comprises issuing a bid request 206 to all or some of the acquirers 110.

The bid request 206 may comprise or be communicated by any type of electronic and/or network communication between the payment processing system 102 and the acquiring banks 110. The bid request 206 may be “pushed” by the payment processing system 102 to the acquirers 110 or “pulled” by the acquirers 110 from the bidding module 120 of the payment processing system 102.

The bid request 206 may specify a category criterion as described above. In some cases, the bid request 206 may also specify a number of transactions that are to processed under the terms of any bids that are submitted in response to the bid request.

In order to specify the category criterion, the bid request may include a list of attributes and respectively corresponding value sets as described above. In other embodiments, the bid request 206 may instead specify a category by specifying a category identifier that has been agreed upon by the parties to indicate a particular combination of attributes and corresponding attribute values.

The bid request 206 may include a request ID, which is a unique value or code corresponding to the bid request, and which may be used to distinguish between different bid requests.

An action 208, performed by computing devices of some or all of the acquirers 110, comprises communicating over the data communications network to receive the bid request 206.

An action 210, performed by computing devices of some or all of the acquirers 110, comprises determining an acquirer amount, indicating the fee that will be charged for the group of future transactions that are specified by the bid request 206. The acquirer amount may be determined algorithmically by the computing devices of the acquiring banks, based on specified factors, constraints, real-time market conditions, and past histories of accepted and rejected bids. In some cases, the acquiring bank may account for the relative risk of transactions of the specified transaction category, and may bid more for higher-risk categories and lower for lower-risk categories. Generally, the individual acquirers 110 may implement different strategies for determining fee amounts to be bid in response to bid requests, and each acquirer 110 may bid a different fee amount.

An action 212, performed by computing devices of some or all of the acquirers 110, comprises compiling and submitting a bid 214 to the payment processing system 102. The bid 214 refers to the bid request by the previously mentioned request ID and specifies a price or fee amount for processing the specified number of transactions that satisfy the category criterion of the bid request 206. The fee amount may be specified on a per-transaction basis or as an aggregate fee for the number of transactions specified by the bid request 206. The fee amount may be specified as an absolute value, as a percentage of the transaction amount, or a combination of the two.

An action 216, performed by computing devices of the payment processing system 102, comprises receiving the bids 214 from each of multiple acquirers 110.

An action 218 comprises selecting and notifying a winning acquirer 110. More specifically, the action 218 comprise selecting one of the submitting acquirers 110 based at least in part on the fee amounts of the submitted bids 214. In certain embodiments, this may comprise selecting the submitting acquirer 110 that submitted the lowest-cost bid, such as the bid that specified the lowest price or fee amount.

The action 218 may include sending a notification 220 to the winning acquirer 110, which is received by the winning acquirer 110 in an action 222. The notification 220 may specify the request ID of the request 206 to which the notification pertains. In some cases, similar notifications may be sent to the other, non-winning acquirers 110, notifying them that their bids were not selected.

An action 224, performed by computing devices of the payment processing system 102, comprises storing the winning bid in a database 226 so that it can be referenced later. For each of multiple accepted bids, the database 226 indicates the winning acquirer, the terms of the bid such as the bid fee amount, the number of remaining transactions that can be processed under the terms of the bid, and any other data relevant to future actions by the payment processing system 102.

The action 222 comprises receiving the notification 220 by the computers of the winning acquirer 110. An action 228, performed by the winning acquirer 110, comprises storing the information relating to the accepted bid and associated bid request in a database 230 for later reference. Accepted bids and requests may be referenced by request ID. The stored information for an accepted bid may include the category or criterion of the associated bid request as well as the terms that were accepted by the payment processing system 102 for processing transactions that are within the category.

The example method 200 may be repeated for multiple bid requests, corresponding to different transaction categories. Specifically, the bidding module 120 may issue multiple bid requests corresponding respectively to different categories, and may receive bids from multiple acquirers. From the submitted bids, the bidding module 120 selects winning bids that correspond respectively to the different transaction categories and groups of transactions.

The example method 200 may also be repeated over time for each category, for additional groups of transactions meeting the corresponding transaction criterion.

In some cases or implementations, a bid request may be for transactions that are initiated by a merchant after selecting the winning bid. In other cases or implementations, a bid request may be for transactions that have already been initiated and for which transaction requests have been received, but for which the authorization and/or capture process has not yet been initiated or completed. For example, the payment processing system may queue multiple transaction requests for one or two seconds, and then issue one or more bid requests for the pending transactions represented by the queued transaction requests. Winning bids may be selected for different transaction categories, and the pending transactions may then be routed to the acquirers that have submitted the winning bids. That is, authorizations for the pending transactions may be performed using the acquiring banks that submitted the winning bids.

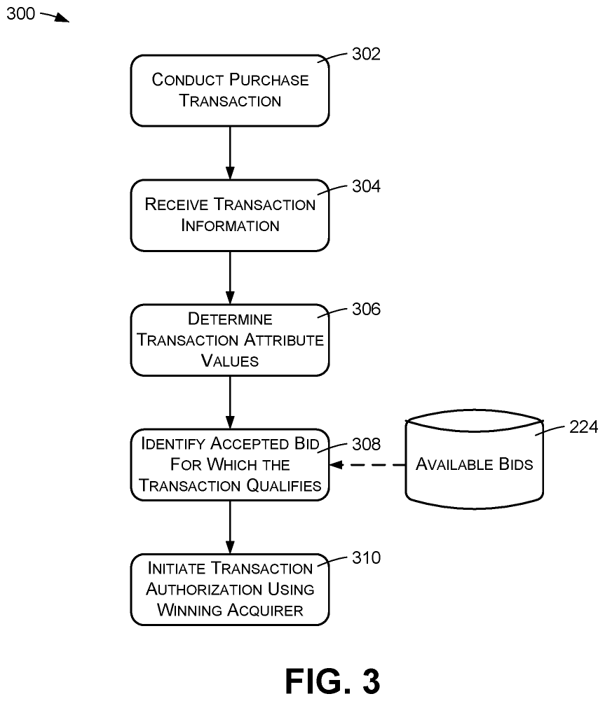

FIG. 3 illustrates an example method 300 for processing purchase transactions in accordance with previously issued bid requests. The method 300 may be performed in the environment of FIG. 1 or in other environments. The actions shown in FIG. 3 may be performed by the POS device 106 or by computing devices of the payment processing system 102, such as by the transaction module 104 of the payment processing system 102.

An action 302, performed by the POS device 106, comprises accepting a payment instrument to initiate a new purchase transaction. The POS device 106 communicates transaction information to the payment processing system 102, including an identifier such as a card number of the payment instrument.

An action 304, performed by computing devices of the payment processing system 102, comprises receiving the transaction information regarding the purchase transaction from the POS device 106.

An action 306, performed by computing devices of the payment processing system 102, comprises determining the attribute values of the transaction, based at least in part on the received transaction information. The transaction information may explicitly indicate certain attribute values, including the transaction amount, a transaction time, and an identifier, such as a card number, of the payment instrument being used for payment. The transaction information may also indicate values corresponding to other attributes. In some cases, the transaction information may indicate information from which the certain attribute values can be derived. Generally, attribute values may be provided by the POS device 106, may be derived from information provided by the POS device, or may be known to the payment processing system 102 apart from any received transaction information. Attributes relating to the merchant, for example, may be known to the payment processing system 102 apart from the transaction information for any particular purchase transaction.

An action 308, performed by computing devices of the payment processing system 102, comprises identifying an accepted bid or other response for which the purchase transaction qualifies, and further, identifying the winning acquirer that submitted the bid.

The action 308 may comprise accessing the database 226 to find accepted bids and their criteria. Based on this information, the payment processing system 102 may determine that (a) a particular purchase transaction satisfies the category criterion of a particular transaction category, and (b) there is a winning bid, by a particular winning acquirer, for the particular transaction category. A transaction satisfies the category criterion if the transaction has attribute values that are within the value sets of the category criterion. Thus, for any specific attribute of the criterion, the action 308 comprises determining that the purchase transaction has a value for that attribute that is one of the values specified by the value set for that attribute.

An action 310, performed by computing devices of the payment processing system 102, comprises initiating payment for the purchase transaction to the winning acquirer identified in the action 308, from an issuing bank of the payment instrument provided by the customer. This action may involve communicating with the winning acquirer to initiate authorization and capture of the transaction using the payment instrument submitted by the customer.

The method 300 is performed repeatedly, for each received purchase transaction. Received purchase transactions may fall within different categories, and may therefore be processed by different acquirers.

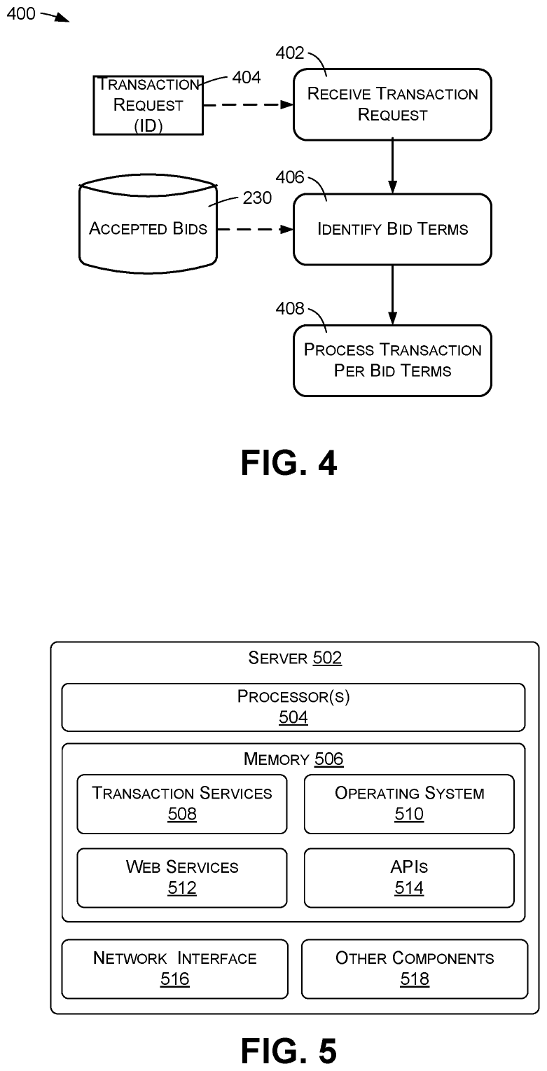

FIG. 4 illustrates an example method 400 that may be performed by a winning acquirer for processing purchase transactions. The method 400 may be performed in the environment of FIG. 1 or in other environments.

An action 402 comprises communicating over a data communications network to receive a transaction request 404 for a purchase transaction from the payment processing system 102. The transaction request 404 may indicate the request ID associated with a bid made by the winning acquirer, under which the request is being submitted. The purchase transaction is for a purchase amount and has attribute values that satisfy the category criterion associated with the bid. The transaction request 404 may indicate various transaction information regarding the purchase transaction, and may in some cases include values for any of the transaction attributes described above.

An action 406 comprises identifying the terms of the bid associated with the request ID specified by the transaction request 404, by referencing the database 230, which contains information about winning bids made by the acquirer.

An action 408 comprises processing the transaction in accordance with the terms of the bid specified by the transaction request 404. The action 408 may include receiving a funds transfer from an issuing bank, and depositing received funds into a bank account associated with the payment processing system 102. The action 408 may further include calculating or otherwise determining an acquirer amount in accordance with the bid and deducting the acquirer amount from the original transaction amount. For example, the action 408 may comprise calculating an adjusted amount for the purchase transaction and depositing the adjusted amount into the bank account associated with the payment processing system 102, wherein the adjusted amount comprises the original transaction amount minus one or more processing fees, and wherein the one or more processing fees include the acquirer amount, the payment network fee, and any issuer fees.

FIG. 5 shows an example of a computing device or server 502, which may be used to implement the functionality of the payment processing system 102 as described herein. Generally, the payment processing system 102 may be implemented by a plurality of servers 502, and may be programmed or otherwise configured to perform the actions that are attributed herein to the payment processing system 102. A computing device such as shown in FIG. 5 may similarly be used by or on behalf of an acquiring bank 110 to implement the actions that are attributed herein to the acquiring bank 110.

Generally, the computing device 502 may comprise a general purpose or specialized computer, such as a desktop computer or rack-mounted computer. In some cases, the server 502 may support virtual servers, and some of the elements shown in FIG. 5 may be implemented by virtual computer servers.

In the illustrated example, the computing device 502 includes at least one processor 504 and associated memory 506. Each processor 504 may itself comprise one or more processors or processing cores. For example, the processor 504 can be implemented as one or more microprocessors, microcomputers, microcontrollers, digital signal processors, central processing units, state machines, logic circuitries, and/or any devices that manipulate signals based on operational instructions. In some cases, the processor 504 may be one or more hardware processors and/or logic circuits of any suitable type specifically programmed or configured to execute the algorithms and processes described herein. The processor 504 can be configured to fetch and execute computer-readable processor-executable instructions stored in the memory 506.

Depending on the configuration of the computing device 502, the memory 506 may be an example of tangible non-transitory computer storage media and may include volatile and nonvolatile memory and/or removable and non-removable media implemented in any type of technology for storage of information such as computer-readable processor-executable instructions, data structures, program modules or other data. The memory 506 may include, but is not limited to, RAM, ROM, EEPROM, flash memory, solid-state storage, magnetic disk storage, optical storage, and/or other computer-readable media technology. Further, in some cases, the computing device 502 may access external storage, such as RAID storage systems, storage arrays, network attached storage, storage area networks, cloud storage, or any other medium that can be used to store information and that can be accessed by the processor 504 directly or through another computing device or network. Accordingly, the memory 506 may be computer storage media able to store instructions, modules or components that may be executed by the processor 504. Further, when mentioned, non-transitory computer-readable media exclude media such as energy, carrier signals, electromagnetic waves, and signals per se.

The memory 506 may be used to store and maintain any number of functional components that are executable by the processor 504. In some implementations, these functional components comprise instructions or programs that are executable by the processor 504 and that, when executed, implement operational logic for performing the actions and services attributed above to the payment processing system 102 or the acquiring bank 110. For example, the transaction module 104 and the bidding module 120 may be stored in the memory for access and execution by the processor 504. The databases 226 and 230, which store information related to accepted bids, may also be stored in the memory 506.

Additional functional components may include an operating system 510 and a web services component 512. The memory 506 may also store APIs (application programming interfaces) 514 that are used for communications between the computing device 702 other network-accessible entities such as the POS device 106 and the computing devices of the acquiring bank 110. The memory 506 may also store data, data structures and the like, that are used by the functional components.

The computing device 502 may have a network communications interface 516, such as an Ethernet communications interface, which provides communication by the computing device 502 with other servers, with the Internet, with POS devices and/or other peripherals or terminals, etc.

The computing device 502 may of course include many other logical, programmatic, and physical components 518 that are not specifically described herein.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

1. A method comprising:
communicating, by one or more computers of a payment processing system, with multiple acquirers to solicit responses from the multiple acquirers for processing future payment exchanges associated with a transaction category, wherein the multiple acquirers receive funds from one or more issuers on behalf of the payment processing system;
receiving, by the one or more computers and in response to communicating with the multiple acquirers, responses from the multiple acquirers, wherein each response indicates a cost to be charged by a respective acquirer for processing the future payment exchanges associated with the transaction category;
selecting, by the one or more computers, an acquirer from the multiple acquirers based at least in part on the acquirer providing a response indicating a lowest cost for processing the future payment exchanges associated with the transaction category;
at a time after the acquirer has been selected, receiving, by the one or more computers and from a point-of-sale (POS), exchange information regarding a new payment exchange;
determining, by the one or more computers and based at least in part on the exchange information, that the new payment exchange is associated with the transaction category; and
in response to determining that the new payment exchange is associated with the transaction category, communicating, by the one or more computers and with the previously selected acquirer to initiate processing of the new payment exchange.

2. The method of claim 1, further comprising, identifying, by the one or more computers of the payment processing system, the transaction category based at least in part on one or more attributes associated with at least one previous payment exchange,
wherein the transaction category defines one or more value sets corresponding respectively to the one or more attributes, and wherein each value set of the one or more value sets comprises a value, multiple values, or a range of values.

3. The method of claim 1, further comprising identifying, by the one or more computers of the payment processing system, the transaction category based at least in part on one or more attributes associated with at least one previous payment exchange,
wherein at least one attribute of the one or more attributes relates to a chargeback risk.

4. The method of claim 1, further comprising identifying, by the one or more computers of the payment processing system, the transaction category based at least in part on one or more attributes associated with at least one previous payment exchange,
wherein the one or more attributes indicate, for the at least one previous payment exchange, one or more of:
an amount of the at least one previous payment exchange;
a time-of-day of the at least one previous payment exchange;
a time of the at least one previous payment exchange;
an identity of an entity conducting the at least one previous payment exchange;
a category code corresponding to the entity conducting the at least one previous payment exchange;
a measure of chargebacks for past payment exchanges conducted by the entity conducting the at least one previous payment exchange;
a measure of chargebacks for past payment exchanges conducted with an issuer of the instrument being used for the at least one previous payment exchange;
a credit rating of the entity conducting the at least one previous payment exchange;
whether the at least one previous payment exchange was a card-present payment exchange;
whether the at least one previous payment exchange was a telephone-based payment exchange;
whether the at least one previous payment exchange was an online payment exchange;
an issue date of another instrument used for the at least one previous payment exchange;
an expiration date of the other instrument used for the at least one previous payment exchange;
a county of an issuing bank associated with the other instrument used for the at least one previous payment exchange;
a bank identification number (BIN) associated with the other instrument used for the at least one previous payment exchange;
a product type of one or more products being purchased as part of the at least one previous payment exchange;
an identity of an issuer of the other instrument used for the at least one previous payment exchange; or
a geographic location where the at least one previous payment exchange was conducted.

5. A system associated with a merchant services provider, the system comprising:
one or more processors;
one or more non-transitory computer-readable media storing instructions executable by the one or more processors, wherein the instructions program the one or more processors to perform acts comprising:
communicating over a data communications network with multiple acquirers to solicit, from the multiple acquirers, first responses for processing one or more future payment exchanges associated with a first transaction category, wherein the multiple acquirers receive funds from one or more issuers on behalf of the merchant services provider;
receiving, in response to communicating with the multiple acquirers, the first responses from the multiple acquirers;
selecting a first acquirer from the multiple acquirers based at least in part on the first responses, wherein the first acquirer is associated with a response of the first responses indicating a lowest cost for processing the one or more future payment exchanges associated with the first transaction category;
at a time after the acquirer has been selected, receiving exchange information associated with a first payment exchange;
determining, based at least in part on the exchange information, that the first payment exchange is associated with the first transaction category; and
initiating, in response to the determining, processing of the first payment exchange using the first acquirer, as previously selected from the multiple acquirers.

6. The system of claim 5, wherein the first transaction category specifies one or more value sets corresponding respectively to one or more attributes associated with the first transaction category, and wherein a particular payment exchange is determined to be associated with the first transaction category when the particular payment exchange has one or more attribute values for individual attributes of the one or more attributes that are within the one or more value sets specified by the first transaction category.

7. The system of claim 6, wherein each value set of the one or more value sets comprises a value, multiple values, or a range of values.

8. The system of claim 6, wherein at least one of the one or more attributes relates to a chargeback risk.

9. The system of claim 5, wherein the initiating comprises communicating with the first acquirer.

10. The system of claim 5, wherein each of the first responses from the multiple acquirers represents a bid by a respective acquirer to process the one or more future payment exchanges associated with the first transaction category.

11. The system of claim 5, the acts further comprising:
communicating with the multiple acquirers to obtain second responses for processing one or more future payment exchanges associated with a second transaction category;
selecting a second acquirer from the multiple acquirers based at least in part on the second responses;
receiving, at a time after the second acquirer has been selected, exchange information regarding a second payment exchange;
determining, based at least in part on the exchange information regarding the second payment exchange, that the second payment exchange is associated with the second transaction category; and
initiating processing of the second payment exchange using the second acquirer instead of the first acquirer.

12. A method, implemented at least in part by one or more computing devices of a payment processing system, the method comprising:
receiving exchange information for one or more previous payment exchanges, wherein individual payment exchanges of the one or more previous payment exchanges correspond to individual transaction categories of one or more transaction categories;
receiving, from multiple acquirers, responses for processing future payment exchanges associated with the one or more transaction categories, wherein the multiple acquirers receive funds from one or more issuers on behalf of the payment processing system;
in response to receiving the responses, selecting a first response that indicates a lowest cost associated with processing one or more of the future payment exchanges that are associated with a first transaction category of the one or more transaction categories;
receiving, at a time after a first acquirer corresponding to the first response has been selected, exchange information for a first payment exchange;
determining, based at least in part on the exchange information, that the first payment exchange is associated with the first transaction category; and
initiating processing of the first payment exchange using the first acquirer associated with the first response, as previously selected from the multiple acquirers.

13. The method of claim 12, wherein each response is for a specified quantity of payment exchanges of a particular transaction category.

14. The method of claim 12, wherein the one or more transaction categories correspond to one or more respective risk categories.

15. The method of claim 12, wherein:
the first transaction category specifies one or more value sets corresponding respectively to one or more attributes of the one or more previous payment exchanges; and
a particular payment exchange of the one or more previous payment exchanges satisfies a criterion for a particular transaction category of the one or more transaction categories when the particular payment exchange has one or more attribute values that are within respectively corresponding value sets of the particular transaction category.

16. The method of claim 15, wherein each value set of the one or more value sets comprises a value, multiple values, or a range of values.

17. The method of claim 15, wherein at least one of the one or more attribute values relates to a financial risk of processing the one or more previous payment exchanges.

18. The method of claim 12, wherein the initiating comprises communicating with the first acquirer.

19. The method of claim 12, further comprising:
receiving second exchange information for a second payment exchange;
determining, based at least in part on the second exchange information, that the second payment exchange corresponds to a second transaction category of the one or more transaction categories, wherein the second transaction category is different than the first transaction category;
identifying a second acquirer associated with a second response associated with the second transaction category, wherein the second acquirer is different than the first acquirer; and
initiating processing of the second payment exchange using the second acquirer instead of the first acquirer.

20-23. (canceled)

24. One or more non-transitory computer-readable media storing instructions that, when executed by one or more processors, program the one or more processors to perform acts comprising:
identifying a transaction category associated with at least one previous payment exchange;
communicating, by one or more computers of a support system, with multiple acquirers to solicit responses from individual acquirers of the multiple acquirers for processing one or more future payment exchanges associated with the transaction category, wherein the multiple acquirers receive funds from one or more issuers on behalf of the support system;
receiving, by the one or more computers and in response to communicating with the multiple acquirers, the responses from the multiple acquirers;
selecting, by the one or more computers, an acquirer from the multiple acquirers based at least in part on the acquirer providing a response indicating a lowest cost associated with processing the one or more future payment exchanges;
receiving, by the one or more computers and from a point-of-sale (POS) and at a time after the acquirer has been selected, exchange information regarding a new payment exchange, wherein the exchange information is associated with an instrument;
determining, by the one or more computers and based at least in part on the exchange information, that the new payment exchange is associated with the transaction category; and
in response to determining that the new payment exchange is associated with the transaction category, communicating, by the one or more computers and with the previously selected acquirer to initiate processing of the new payment exchange.

25. The one or more non-transitory computer-readable media of claim 24, wherein the transaction category defines one or more value sets corresponding respectively to one or more attributes, and wherein each value set of the one or more value sets comprises a value, multiple values, or a range of values.

26. The one or more non-transitory computer-readable media of claim 25, wherein at least one of the one or more attributes relates to a chargeback risk.

27. The one or more non-transitory computer-readable media of claim 24, wherein the transaction category is determined based at least in part on one or more attributes that indicate, for the at least one previous payment exchange, one or more of:
an amount of the at least one previous payment exchange;
a time-of-day of the at least one previous payment exchange;
a time of the at least one previous payment exchange;
an identity of an entity conducting the at least one previous payment exchange;
a category code corresponding to the entity conducting the at least one previous payment exchange;
a measure of chargebacks for past payment exchanges conducted by the entity conducting the at least one previous payment exchange;
a measure of chargebacks for past payment exchanges conducted with an issuer of the instrument being used for the at least one previous payment exchange;
a credit rating of the entity conducting the at least one previous payment exchange;
whether the at least one previous payment exchange was a card-present payment exchange;
whether the at least one previous payment exchange was a telephone-based payment exchange;
whether the at least one previous payment exchange was an online payment exchange;
an issue date of another instrument used for the at least one previous payment exchange;
an expiration date of the other instrument used for the at least one previous payment exchange;
a county of an issuing bank associated with the other instrument used for the at least one previous payment exchange;
a bank identification number (BIN) associated with the other instrument used for the at least one previous payment exchange;
a product type of one or more products being purchased as part of the at least one previous payment exchange;
an identity of an issuer of the other instrument used for the at least one previous payment exchange; or
a geographic location where the at least one previous payment exchange was conducted.
